(19) United States
(12) Patent Application Publication
(10) Pub. No.: US 2022/0410662 A1
(43) Pub. Date: Dec. 29, 2022

(54) HEATING STRUCTURE FOR A MOTOR VEHICLE

(71) Applicant: Valeo Systemes Thermiques, Le Mesnil Saint-Denis (FR)

(72) Inventors: Nicolas Devienne, Le Mesnil Saint-Denis (FR); Samuel Ahizi, Le Mesnil Saint-Denis (FR); Naveen Nagendran Goutham, Le Mesnil Saint-Denis (FR)

(73) Assignee: Valeo Systemes Thermiques, Le Mesnil Saint-Denis (FR)

(21) Appl. No.: 17/760,978

(22) PCT Filed: Sep. 8, 2020
(86) PCT No.: PCT/FR2020/051549

§ 371 Date: Mar. 16, 2022

(30) Foreign Application Priority Data
Sep. 19, 2019 (FR) 1910330

(51) Int. Cl. B60H 1/22

(52) U.S. Cl. CPC B60H 1/2227; B60H 1/2226

(57) ABSTRACT

The invention relates to a heating structure (30) intended in particular for installation inside a passenger compartment of a vehicle, this structure being in particular a radiant panel, the heating structure (30) comprising at least one resistive layer arranged to give off heat when an electric current flows through this layer (31), this structure further comprising an array of electrodes (32) comprising a plurality of contact electrodes (33) that are arranged so as to be in electrical contact with the resistive layer in order to make electric current flow through this resistive layer, at least two of these contact electrodes being in contact with a region of the resistive layer (31), these two contact electrodes facing one another such that electric current can flow from one of these electrodes to the other of the contact electrodes by passing through this region of the resistive layer, these two contact electrodes (33) on either side of said region taking a shape chosen such that the two electrodes get closer to one another over a portion (38) of the electrodes and stay further away at the ends (39) of these electrodes.

The present invention relates to a heating structure intended in particular to be installed inside a passenger compartment of a vehicle, this structure being in particular a radiant panel.

Generally, a radiant panel comprises a plurality of electrodes designed to provide heat through Joule heating by supplying an electric current to a conductive coating. Reference may be made, for example, to document US 2016/0059669 which describes such a radiant panel.

A radiant panel is a device generally comprising an electrical circuit designed to provide heat through Joule heating by supplying an electric current to resistive conductive elements. These may be filament elements or surface coatings. According to the existing literature, the conductive coating may for example be a paint layer comprising carbon particles and/or metallic particles. One problem found today is the difficulty of obtaining homogeneous heating over the entire surface of the radiant panel, i.e. a heating temperature that does not vary from one point to another on the surface of the radiant panel. This drawback is compounded by geometric constraints since the radiant panel is intended to be arranged in different parts of the passenger compartment (headlining, door, pillar, glove compartment, etc.).

The object of the present invention is to provide improved radiant panels.

The present invention thus relates to a heating structure, in particular a flexible or soft heating structure, intended in particular to be installed inside a passenger compartment of a vehicle, this structure being in particular a radiant panel, the heating structure comprising at least one resistive layer designed to produce a thermal output when this layer is flowed through by an electric current, this structure furthermore comprising an electrode array comprising a plurality of contact electrodes arranged so as to be in electrical contact with the resistive layer in order to channel electric current through this resistive layer, at least two of these contact electrodes being in contact with an area of the resistive layer, these two contact electrodes facing one another such that electric current is able to flow from one of these electrodes to the other of the contact electrodes by flowing through this area of the resistive layer, in particular without flowing through another contact electrode, these two contact electrodes bordering said area having a shape chosen such that the two electrodes come closer to one another over a portion of the electrodes and remain further apart at the ends of these electrodes.

In one example of the invention, these two electrodes each comprise a single branch, without any offshoots.

According to the invention, the mutual distance between the two contact electrodes is smaller over one portion of these electrodes and greater over another portion of the electrodes. The portion facing the smallest mutual distance is in particular substantially in the middle of the length of the contact electrodes.

The contact electrodes with the variable mutual distances are connected to distribution electrodes, in particular parallel ones, arranged such that the directions of the current flowing therein oppose one another. It may be said that there are crossing current flows in the distribution electrodes.

Thus, the electrical resistance encountered by the current lines between these two electrodes, and passing through the area of the resistive layer, may be substantially uniform.

The invention makes it possible in particular to overcome the problem of inhomogeneity of the heating in a heating structure, in particular a radiant panel, under connection to crossing current flows. Specifically, when using a crossing flow approach, a voltage drop is observed over the length of each electrode. This phenomenon leads to a weaker current flowing through the center of the radiant panel.

Since the power delivered by the heating structure is directly proportional to the current flowing through the structure, this undesirable effect results in inhomogeneous heating along the resistive layer. In some cases, this may lead to thermal discomfort or thermal inefficiency. The invention makes it possible to have greater heating homogeneity, in particular by adapting the distance between the electrodes on the basis of the value of the differential voltage loss.

In particular, the invention, by virtue of the appropriate reduction in the mutual distance, makes it possible to make the heating power output by the area of the resistive layer substantially uniform.

According to one of the aspects of the invention, the electric current flows in opposing directions in the two distribution electrodes.

According to one of the aspects of the invention, the distance between the two electrodes is minimal in respective central portions of the two electrodes, in particular substantially in the middle of these electrodes.

According to one of the aspects of the invention, the edges of at least one of the electrodes have a concavity directed away from the other, facing electrode.

According to one of the aspects of the invention, at least one of the edges is rounded.

According to one of the aspects of the invention, at least one of the edges has portions in the form of a straight segment.

According to one of the aspects of the invention, one of the edges of the electrode is straight and the other edge has a non-straight shape, in particular rounded or in the form of straight segments, in particular in the form of a vertex of a triangle.

According to one of the aspects of the invention, the two electrodes exhibit symmetry about an axis of symmetry over the majority of their length.

According to one of the aspects of the invention, the heating structure comprises electrodes with two edges adjacent to a resistive layer area, and these two edges of the electrode exhibit axial symmetry, and these edges each have a concavity directed respectively toward the other edge.

According to one of the aspects of the invention, these symmetrical edges each comprise, for example, a corner shape or a rounded shape, in particular with the vertex of the corner or the top of the rounding substantially in the middle of the electrode.

According to one of the aspects of the invention, the separate electrodes have different shapes.

According to one of the aspects of the invention, the contact electrodes located at the ends have different shapes with respect to the intermediate electrodes between these contact electrodes, in particular one edge is straight and the other edge is curved in the direction of the other electrode on the other side of the area of the resistive layer.

According to one of the aspects of the invention, the electrode array comprises distribution electrodes arranged so as to channel electric current from an electrical source to the contact electrodes, several contact electrodes being connected to one and the same distribution electrode.

According to one of the aspects of the invention, the at least one of the distribution electrodes is rectilinear over at least part of its length, and the contact electrodes associated with this distribution electrode are connected for example perpendicularly to this distribution electrode.

Naturally, the distribution electrodes may take different shapes, in particular curved with roundings. The distribution electrodes may or may not be mutually parallel.

According to one of the aspects of the invention, the electrode array comprises at least two distribution electrodes which are mutually parallel over at least part of their length, and their associated contact electrodes are arranged between these two distribution electrodes and alternate with a mutual distance which decreases in accordance with the decrease in voltage present between the pairs of electrodes, so as to maintain a substantially uniform electrical power between the pairs of contact electrodes.

According to one of the aspects of the invention, the contact electrodes which are arranged between two distribution electrodes, these contact electrodes forming part of one and the same group of contact electrodes, have only two mutual distance values or at least three or more mutual distance values.

According to one of the aspects of the invention, the resistive layer is a layer deposited on a substrate in particular by screen printing, this resistive layer extending in particular between the two distribution electrodes associated with the group of contact electrodes.

According to one of the aspects of the invention, the resistive layer comprises in particular carbon.

According to one of the aspects of the invention, the electrodes are made of conductive material, in particular metal, such as ink loaded with conductive particles, in particular particles of silver or copper. If desired, the electrodes are metallic adhesive strips, for example made of copper. Where applicable, these electrodes may possibly be formed by deposition of a material on the substrate.

According to one of the aspects of the invention, the resistive layer associated with the group of contact electrodes is a continuous layer, or as a variant comprises a plurality of discrete resistive elements forming this layer.

According to one of the aspects of the invention, the contact electrodes of one and the same group have the same length.

According to one of the aspects of the invention, the heating structure comprises a substrate which carries the resistive layer and the electrodes. The substrate preferably has a thickness of less than 1 cm for a surface area of several cm² at least.

The heating structure is in particular in the form of one or more layers.

The invention furthermore concerns a component of a passenger compartment of a motor vehicle, in particular a component to be integrated into a vehicle door, or in particular parts of the dashboard, the footwell trim, the headlining, the armrest, comprising a heating structure, in particular a radiant panel, as described above.

According to one of the aspects of the invention, the passenger compartment component which comprises the heating structure, for example the radiant panel, is designed to heat by thermal radiation (radiant panel) or by thermal conduction or thermal contact (contact heating structure), and not by convection heating, for example by heat carried by moving air. In particular, no air flow passes through the heating structure for cooling or heating of the passenger compartment. Preferably, the panel is disconnected from the air circulation system.

The heating structure and the HVAC (“Heating, Ventilation and Air-Conditioning”) of the vehicle may, if desired, be controlled in a coordinated manner.

The component forms, for example, an element of a glove compartment or door panel of the vehicle, or the roof of passenger compartment.

The invention furthermore concerns a heating structure having a resistive layer and electrodes for heating this layer, this structure being designed to be integrated into a passenger compartment component which comprises a decor element visible from the interior of the passenger compartment, this decor element being, for example, a trim element of the passenger compartment, such as for example a fabric, leather or esthetic covering.

It is understood that the set of features and configurations above is in no way limiting. Further features, details and advantages of the invention will become more clearly apparent from reading the detailed description given below, and several exemplary embodiments that are given by way of non-limiting indication, with reference to the attached schematic drawings, in which:

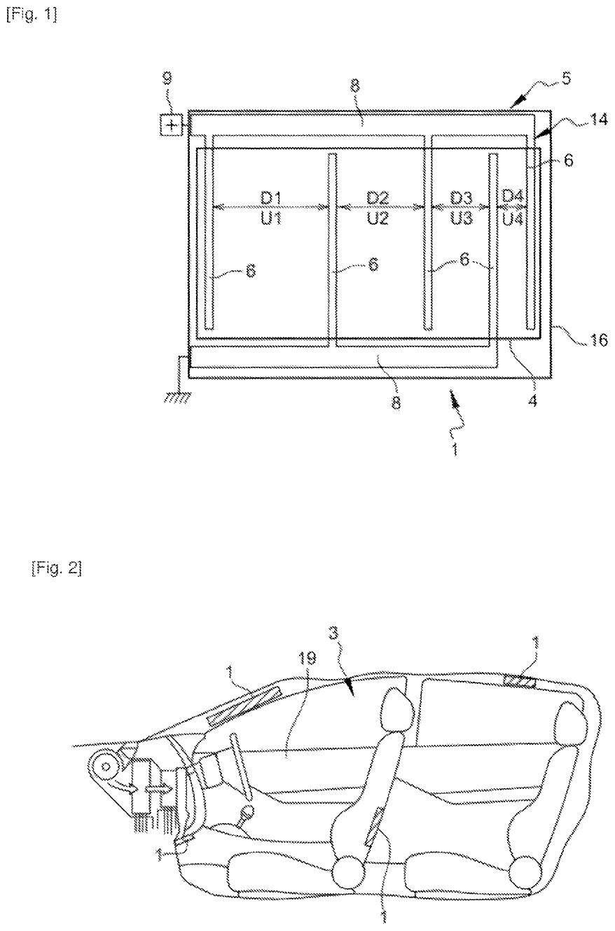

FIG. 1 is a schematic illustration of one exemplary embodiment of a radiant panel according to one exemplary embodiment of the invention;

FIG. 2 is a schematic illustration of components including the radiant panel of the invention;

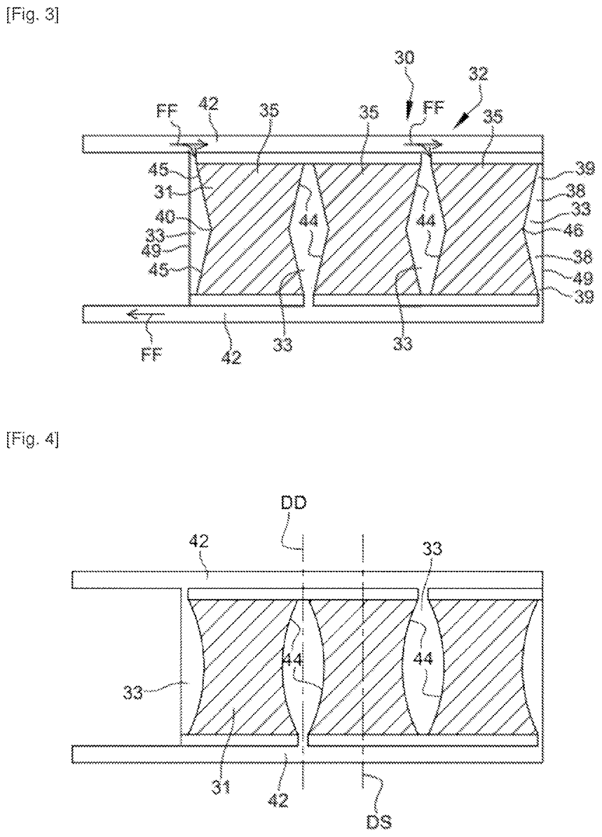

FIG. 3 is a schematic illustration of another example of the invention,

FIG. 4 is a schematic illustration of another example of the invention.

FIG. 1 shows a radiant panel 1 forming a heating structure in the sense of the invention, and designed to be installed inside a passenger compartment 3 of a vehicle.

The radiant panel 1 comprises a resistive layer 4 which is designed to produce a thermal output when an electric current passes through this layer 4.

The resistive layer 4 is, for example, an acrylic paint loaded with conductive or semi-conductive particles. This conductive filler takes the form of carbon or graphite flakes for example.

This panel 1 also comprises an electrode array 5 comprising a plurality of contact electrodes 6 which are arranged to be in electrical contact with the resistive layer 4 in order to channel an electric current through this resistive layer 4.

These contact electrodes 6 are arranged with a mutual distance D1, D2, . . . Di between successive electrodes, which mutual distance is variable.

These contact electrodes 6 are rectilinear and mutually parallel in the example described.

The electrode array 5 comprises distribution electrodes 8 designed to channel electric current to the contact electrodes 6, wherein one of these electrodes 8 is connected to an electrical source 9, for example of positive electrical polarity. The other distribution electrode 8 is connected to another polarity, for example being connected to ground.

The electric current thus flows through a distribution electrode 8 which distributes it into the contact electrodes 6. The current then flows in the resistive layer 4 before being collected by the contact electrodes 6 connected to the other distribution electrode 8.

Several contact electrodes 6 are connected to one and the same distribution electrode 8.

The distribution electrodes 8 are rectilinear over part of their length, even over their entire length, and the contact electrodes 6 associated with these distribution electrodes 8 are connected perpendicularly to this associated distribution electrode 8.

Here, the electrode array 5 comprises two mutually parallel distribution electrodes 8, and their associated contact electrodes 6 are arranged between these two distribution electrodes 8 and alternate with a mutual distance D1, D2 . . . Di, which decreases in accordance with the decrease in voltage U1, U2 . . . Ui present between the pairs of electrodes 6, so as to maintain a substantially uniform electrical power between the pairs of contact electrodes.

The contact electrodes 6 which are arranged between the two distribution electrodes 8, these contact electrodes forming part of one and the same group 14 of contact electrodes, have a plurality of mutual distance values D1, D2, . . . Di. In the example described, D1>D2>D3>D4 and U1>U2>U3>U4 are for the voltages between the electrodes 6.

The resistive layer 4 is a layer deposited on a substrate 16, in particular by screen printing, this resistive layer 4 extending in particular between the two distribution electrodes 8 associated with the group of contact electrodes. The substrate 16 is for example made of nonwoven, and is soft and flexible.

The electrodes 6 and 8 are made of conductive material, in particular metal, such as ink loaded with conductive particles, in particular particles of silver or copper.

In the example described, the resistive layer 4 associated with the group of contact electrodes is a continuous, substantially rectangular layer. Other shapes are naturally conceivable.

The contact electrodes 6 of one and the same group 14 have the same length. As a variant, the electrodes 6 may have different lengths.

In an example which is not shown, several pairs of distribution electrodes 8 may be provided, and there are then several groups 14 of contact electrodes 6.

A passenger compartment component 19 of a motor vehicle, in particular a component to be integrated into a door of the vehicle, is provided with a radiant panel 1. Several components may be provided in the passenger compartment.

The component 19 may comprise a decorative layer applied to the radiant panel. The decorative layer may for example be impermeable to air, for example being made of leather.

The distribution electrodes 8 may if desired have more complex shapes, with for example one or more rounded corners connecting rectilinear portions.

In the example described, all mutual distance values Ui of a group 15 are different. As a variant, it is possible that certain mutual distance values of one and the same group are identical, and not all are different.

The substrate may be a sheet or a cloth for example.

The contact electrodes 6 and their associated distribution electrodes 8 are arranged in the manner of enmeshed combs.

In one variant, the heating structure is used in a component of a passenger compartment, being a passenger armrest, wherein the structure may warm the arm of the passenger through thermal contact.

FIG. 3 shows a heating structure 30 according to another exemplary implementation of the invention, comprising a resistive layer 31 designed to produce a thermal output when this layer 31 is flowed through by an electric current, this structure 30 furthermore comprising an electrode array 32 comprising a plurality of contact electrodes 33 arranged so as to be in electrical contact with the resistive layer 31 in order to channel electric current through this resistive layer 31, these contact electrodes 33 being in contact with an area 35 of the resistive layer 31, these contact electrodes 33 facing one another such that electric current is able to flow from one of these electrodes 33 to the other of the contact electrodes 33 by flowing through this area 35 of the resistive layer, in particular without flowing through another contact electrode, these contact electrodes 33 bordering each area 35 having a shape chosen such that the two adjacent electrodes 33 come closer to one another over a portion 38 of the electrodes and remain further apart at the ends 39 of these electrodes.

These contact electrodes 33 each comprise a single branch, without any offshoots.

The mutual distance between two adjacent contact electrodes 33 is smaller over one portion of these electrodes and greater over another portion of the electrodes. The portion facing the smallest mutual distance is in particular substantially in the middle 40 of the length of the contact electrodes 33.

The contact electrodes 33 with the variable mutual distances are connected to distribution electrodes 42, in particular parallel ones, arranged such that the directions of the current, represented by arrows FF, flowing therein oppose one another. It may be said that there are crossing current flows in the distribution electrodes.

In the contact electrodes, the current flows thus cross alternately, specifically the current directions alternate from one contact electrode to another.

The electric current flows in opposing directions in the two distribution electrodes 42.

The distance between two contact electrodes 33 is minimal in the respective middle 40 of the two electrodes.

In the example of FIG. 3, the edges 44 of the intermediate contact electrodes 33 have portions in the form of a straight segment 45 respectively forming corners 46.

As a variant, as illustrated in FIG. 4, the edges 44 are rounded.

In FIGS. 3 and 4, the end electrodes 33 each have a straight edge 49 that is straight and the other edge 44 has a non-straight shape, in particular rounded or in the form of straight segments, in particular in the form of a vertex of a triangle.

The two electrodes exhibit symmetry about an axis of symmetry DS over the majority of their length. The successive electrodes 33 are connected alternately to the distribution electrode 42 on one side and to the other distribution electrode on the other side. These electrodes 33 are thus not connected at the same time to both distribution electrodes 42.

The heating structure comprises intermediate contact electrodes 33 with two edges adjacent to a resistive layer area 35, and these two edges 44 of the electrode exhibit axial symmetry about the axis DD, and these edges 44 each have a concavity directed respectively toward the other edge 44 of this same electrode.

1. A heating structure configured to be installed inside a passenger compartment of a vehicle the heating structure comprising:
at least one resistive layer configured to produce a thermal output when the at least one resistive layer is flowed through by an electric current;
an electrode array comprising a plurality of contact electrodes arranged so as to be in electrical contact with the resistive layer in order to channel electric current through this resistive layer,
at least two of the contact electrodes being in contact with an area of the resistive layer and facing one another such that electric current is able to flow from one of these electrodes to the other of the at least two contact electrodes by flowing through the area of the resistive layer, the at least two contact electrodes bordering said area of the resistive layer having a shape chosen such that the at least two electrodes come closer to one another over a portion of the electrodes and remain further apart at the ends of these electrodes.

2. The heating structure as claimed in claim 1, wherein the electric current flows in opposing directions in two distribution electrodes.

3. The heating structure as claimed in claim 1, wherein the distance between the two contact electrodes is minimal in respective central portions of the two electrodes, substantially in the middle of these electrodes.

4. The heating structure as claimed in claim 1, wherein the edges of at least one of the electrodes have a concavity directed away from the other, facing electrode.

5. The heating structure as claimed in claim 1, wherein at least one of the edges is rounded.

6. The heating structure as claimed in claim 1, wherein at least one of the edges has portions in the form of a straight segment.

7. The heating structure as claimed in claim 1, wherein one of the edges of the electrode is straight and the other edge has a non-straight shape, in particular rounded or in the form of straight segments in the form of a vertex of a triangle.

8. The heating structure as claimed in claim 1, wherein the two electrodes exhibit symmetry about an axis of symmetry over the majority of their length.

9. The heating structure as claimed in claim 1, wherein the heating structure comprises electrodes with two edges adjacent to a resistive layer area, and the two edges of the electrode exhibit axial symmetry, and the two edges each have a concavity directed respectively toward the other edge.

10. The heating structure as claimed in claim 1, wherein the contact electrodes with the variable mutual distances are connected to distribution electrodes parallel ones, arranged such that the directions of the current flowing therein oppose one another.

11. The heating structure as claimed in claim 1, wherein the heating structure is flexible or soft and wherein the heating structure is a radiant panel.
